(19) United States
(12) Patent Application Publication
(10) Pub. No.: US 2013/0009767 A1
(43) Pub. Date: Jan. 10, 2013

(54) SEATBELT REMINDER SYSTEM

(76) Inventor: Joel Knoerr, Columbia, MO (US)

(21) Appl. No.: 13/176,751

(22) Filed: Jul. 6, 2011

(51) Int. Cl. B60Q 1/00

(52) U.S. Cl. 340/457.1

(57) ABSTRACT

The present invention is a seatbelt reminder system utilized by a user with a vehicle with a dashboard with a driver's side, one or more audio speakers and a battery. The system includes a recording device with an activation button that records and playback a seatbelt reminder message and a computer chip in communication with the recording device to store the seatbelt reminder message. The seatbelt reminder message is a personalized message from a loved one, a family member or other closely affiliated person of the user. The vehicle audio speakers are in communication with the computer chip to generate the seatbelt reminder message from the recording device after depressing the activation button. The system can be utilized with an automobile, a van or a truck.

### TECHNICAL FIELD & BACKGROUND

Currently there are limited audio alarms informing vehicle passengers to buckle-up for safety. Contemporary automotive features only allow for a lit display board or a repetitive beeping sound as a prompting signal for seatbelt use, each of which can be easily ignored.

The present invention generally relates to a reminder system. More specifically, the invention is a seatbelt reminder system.

It is an object of the invention to provide a seatbelt reminder system to serve as an audible reminder to utilize a seatbelt.

It is an object of the invention to provide a seatbelt reminder system with a personalized message to a driver to utilize a seatbelt.

What is really needed is a seatbelt reminder system to serve as an audible reminder to utilize a seatbelt with a personalized message to a driver to utilize a seatbelt.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front perspective view of a seatbelt reminder system, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

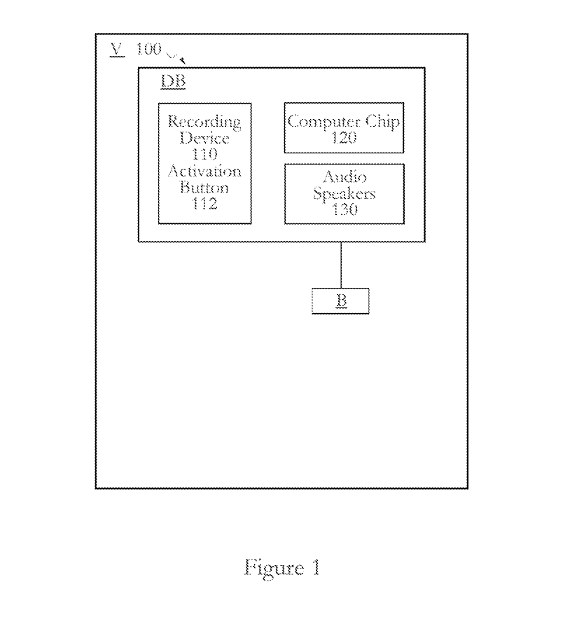

FIG. 1 illustrates a front perspective view of a seatbelt reminder system 100, in accordance with one embodiment of the present invention. The seatbelt reminder system 100 includes a recording device 110, a computer chip 120 and one or more audio speakers 130. The seatbelt reminder system 100 can be disposed on the driver's side of the dashboard DB of a vehicle V and is powered by the battery B of the vehicle V. The vehicle V can be an automobile, a truck, a van or other suitable vehicle.

The recording device 110 includes an activation button 112 that is disposed on the driver's side of the dashboard DB of a vehicle V. The recording device 110 allows a user to record and playback a seatbelt reminder message reminding the user to buckle their seatbelt. The seatbelt reminder message can be a personalized message from a loved one, a family member or other closely affiliated person of the user. The activation button 112 is depressed before a user drives and plays back the seatbelt reminder message. The recording device 110 can be any suitable recording device that can be disposed on a dashboard DB. The computer chip 120 is in communication with the recording device 110 and stores the seatbelt reminder message. The computer chip 120 can be part of a microprocessor, computer or other processing device. The audio speakers 130 are in communication with the computer chip 120 and generate the seatbelt reminder message once the activation button 112 is depressed. The audio speakers 130 can be the audio speakers provided in the vehicle V or be audio speakers separate from the audio speakers provided in the vehicle V.

The seatbelt reminder system plays back a personalized message informing passengers to buckle-up before operating a vehicle. Designed with modern technological capabilities, the seatbelt reminder system adheres to the driver's side of a dashboard and is powered by a standardized car battery. When in use, one can press the button engaging the recording device to save an audio message to an internal computer chip. The message can then be replayed, from the vehicle's audio speakers, reminding operators and/or passengers to protect themselves from physical harm by simply “buckling-up”. The seatbelt reminder system can easily become an endeared method to ensuring patrons engage in safe-driving procedures.

The seatbelt reminder system enables a user to hear heart-felt pleas from their loved ones and friends as a constant reminder to use a seatbelt. The feature of a computer chip, connected to a vehicle's internal speaker system which replays a meaningful “buckle-up” message, introduces a sentimental alternative for encouraging safe-driving behavior.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A seatbelt reminder system utilized with a vehicle and a user, comprising:
a recording device that records and playback a seatbelt reminder message;
a computer chip in communication with said recording device to store said seatbelt reminder message; and
one or more audio speakers in communication with said computer chip to generate said seatbelt reminder message from said recording device.

2. The system according to claim 1, wherein said recording device has an activation button.

3. The system according to claim 2, wherein said audio speakers generate said seatbelt reminder message after depressing said activation button.

4. The system according to claim 3, wherein said seatbelt reminder message is a personalized message from a loved one, a family member or other closely affiliated person of said user.

5. The system according to claim 1, wherein said audio speakers are provided in said vehicle.

6. A seatbelt reminder system utilized with a vehicle with a battery and a user, comprising:
a recording device with an activation button that records and playback a seatbelt reminder, message;
a computer chip in communication with said recording device to store said seatbelt reminder message; and
one or more audio speakers in communication with said computer chip to generate said seatbelt reminder message from said recording device.

7. The system according to claim 6, wherein said audio speakers generate said seatbelt reminder message after depressing said activation button.

8. The system according to claim 7, wherein said seatbelt reminder message is a personalized message from a loved one, a family member or other closely affiliated person of said user.

9. The system according to darn 6, wherein said audio speakers are provided in said vehicle.

10. The system according to claim 6, wherein said system is powered by said vehicle battery.

11. The system according to claim 6, wherein said vehicle includes an automobile, a truck or a van.

12. A seatbelt reminder system utilized by a user with a vehicle with a dashboard with a driver's side, one or more audio speakers, a battery, comprising:
a recording device with an activation button that records and playback a seatbelt reminder message; and
a computer chip in communication with sad recording device to store said seatbelt reminder message, said vehicle audio speakers are in communication with said computer chip to generate said seatbelt reminder message from said recording device.

13. The system according to claim 12, wherein said audio speakers generate said seatbelt reminder message after depressing said activation button.

14. The system according to claim 13, wherein said seatbelt reminder message is a personalized message from a loved one, a family member or other closely affiliated person of said user.

15. The system according to claim 12, wherein said recording device is disposed on said driver's side of said vehicle.

16. The system according to claim 12, wherein said activation button is disposed on said driver's side of said vehicle.

17. The system according to claim 12, wherein said system is powered by said vehicle battery.

18. The system according to claim 12, wherein said vehicle is an automobile.

19. The system according to claim 12, wherein said vehicle is a van.

20. The system according to claim 12, wherein said vehicle is a truck.
